(19) United States
(12) Patent Application Publication
(10) Pub. No.: US 2013/0182865 A1
(43) Pub. Date: Jul. 18, 2013

(54) ACOUSTIC FAULT DETECTION OF MECHANICAL SYSTEMS WITH ACTIVE NOISE CANCELLATION

(71) Applicant: AGCO Corporation, Duluth, GA (US)

(72) Inventor: Matthews Paul, Bel Aire, KS (US)

(73) Assignee: AGCO CORPORATION, Duluth, GA (US)

(21) Appl. No.: 13/730,904

(22) Filed: Dec. 29, 2012

Related U.S. Application Data
(60) Provisional application No. 61/581,892, filed on Dec. 30, 2011.

(51) Int. Cl. G10K 11/00

(52) U.S. Cl. CPC G10K 11/002
USPC 381/71.8

(57) ABSTRACT

An active noise cancellation fault detector (NCFD) is presented that is configured to cancel normal machine noise in an operator cabin, while allowing noise associated with a machine failure mode to remain so that an operator can hear when a machine component is beginning to fail or is in a failure mode. An NCFD can generate a model waveform of normal noise scaled to machine operating parameters. The model waveform can be inverted and adjusted in gain and phase to provide a cancellation waveform. The invention can be configured to determine operator location within a machine cab so that cancellation signals can be configured with the proper phases to destructively interfere with normal machine noise within a quiet zone or noise suppression envelope around an operator. Noise within the quiet zone can be detected and compared to various fault waveforms to determine whether a machine component is beginning to fail.

### CROSS REFERENCE TO RELATED APPLICATIONS

This application claims priority to U.S. Provisional Application No. 61/581,892 filed Dec. 30, 2011, entitled “ACOUSTIC FAULT DETECTION OF MECHANICAL SYSTEMS WITH ACTIVE NOISE CANCELLATION”.

### TECHNICAL FIELD

The present invention relates generally to noise cancellation systems and more particularly to active noise cancellation systems configured to cancel machine noise.

### BACKGROUND

Operator compartments of agricultural machines tend to be louder environments than their automobile counterparts. Not only can high noise levels be irritating to operators, but in some cases they can also contribute to long-term hearing loss. Machine manufacturers often suppress lower frequency dominant noise with passive measures such as the installation of foam or sound baffle, which can reduce ambient noise to internationally acceptable levels. However, installation of such material can increase manufacturing costs while only nominally reducing the machine noise perceived by a cabin occupant. As a result, in spite of the implementation of expensive passive measures, a machine cab can remain a generally loud environment.

Alternative solutions have been proposed that rely on active noise cancellation techniques to provide less expensive and more effective noise suppression than what can be achieved through passive cancellation measures. For example, some consumer audio products, such as Bose™ headphones, use a microphone to detect sound in the environment, use the detected sound to provide a similar waveform opposite in phase, and combine the environmental sound and inverted sound waves so that they cancel each other out, reducing the noise heard by a user.

Relying on this concept, some automobile designers use input from an engine as well as input from microphones placed throughout a passenger cabin to generate a noise cancellation signal that can destructively interfere with cabin noise to reduce the noise heard by a vehicle passenger. This type of noise cancellation process can reduce engine noise heard by drivers and passengers, increasing an occupant's comfort. However, such techniques are not readily applicable to the agricultural industry. Agricultural machines have louder and more complicated noise environments, have heavier and more varied loads on the engines, and also have other onboard systems, such as a threshing system on a combine harvester, which can also produce noise. Skilled operators often learn to detect mechanical malfunctions by attentively listening to and identifying particular machine sounds. Alerted by a machine sound, an operator can promptly inspect/repair a particular malfunctioning component. Quick attention to potential problems can enable an owner or operator to avoid a costly breakdown or more complicated repair that would have resulted had the early stages of the problem been ignored. Systems that attempt to suppress all engine or cabin noise also suppress the sounds that an operator needs to hear to determine whether his machine is operating normally.

### SUMMARY OF THE INVENTION

In an example embodiment, a system of the invention can suppress noise associated with normal machine operations, to provide a quieter cabin while still allowing an operator to hear engine noises that can point to a failing machine component. An example system can provide a model waveform of “ideal” machine noise, and, using the model waveform, provide one or more cancellation audio signals that can destructively interfere with machine noise in a cabin to provide a quiet zone of “cleaned sound” around an operator in which “normal” machine operating noises are suppressed, while sounds associated with abnormal operation remain audible. Thus, an operator can experience a quieter environment and still hear the sounds that can warn him that a machine component is starting to fail or malfunction. In an example embodiment, the “cleaned sound” of the quiet zone can be compared to various failure profiles to detect a failing or potentially failing machine component.

An example embodiment of the invention can determine the position of an operator in the three dimensional cabin space so that a cancellation audio signal having the proper gain and phase can be used to provide a cancellation acoustic signal (waveform) that destructively interferes with cabin noise to produce a quiet zone around an operator. A typical agricultural machine cabin can be equipped with two or more speakers that can be part of an onboard audio system. By determining the position of the operator with respect to the speakers, propagation delays to the operator can be determined so that an acoustic cancellation signal provided by a speaker cancels, rather than reinforces, engine noise within a quiet zone around the operator. The configuration of a quiet zone can allow some degree of operator movement within the noise suppression envelope; however, in an example embodiment, an operator positioning aspect of the invention can detect the occupant position so that a quiet zone can track with the operator within the confines of the cabin.

An example system can be configured to determine the location of an operator's ears. By way of example, but not limitation, a cancellation audio signal can be provided to front and rear left and right speakers, with each speaker receiving a cancellation audio signal having the appropriate gain and phase parameters for operator location relative to the particular speaker so that the cancellation signal interferes with machine noise within the quiet zone surrounding an occupant. In an example embodiment, speakers previously installed at a machine as part of a pre-existing audio system can be used. However, it is also contemplated that speakers can be positioned at specific locations within the cabin that have been determined to optimize configuration of a quiet zone.

A model waveform configured to represent normal operational sounds within a cabin can be scalable with respect to machine parameters, such as, but not limited to, speed, rpm and load. In an example embodiment, a genetic algorithm can be executed that determines the frequencies and amplitudes of a model noise waveform based on engine parameter inputs. Inversion of the model waveform, along with gain adjustments and phase alignments can be performed to provide an audio cancellation signal that can then be provided to a speaker for transduction. The resulting acoustic cancellation signals can interfere with noise in the cabin to provide a quiet zone around an occupant in which normal machine noises are suppressed while abnormal machine sounds are not targeted for cancellation.

The invention further includes a fault detection aspect. In an example embodiment, a microphone can be positioned within a quiet zone to detect the “cleaned” sound that results from the suppression of normal operation noise within the cancellation envelope. The waveform of an audio signal representing the cleaned sound can be compared to one or more fault waveforms in a process similar to that used in voice recognition systems to determine whether the “cleaned” sound indicates a machine component is failing or beginning to deteriorate.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows a machine cabin equipped with an example system of the invention;

FIG. 2 shows an example environment of the invention;

FIG. 3 shows an example method of the invention;

FIG. 4 shows an example embodiment;

FIG. 5A shows a model of an example embodiment of the invention; and

FIG. 5B shows a model of an example embodiment of the invention.

Corresponding reference characters indicate corresponding parts throughout the views of the drawings.

### DETAILED DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, it will be understood that the present invention is not limited to that particular arrangement. Likewise functions discussed in the context of being performed by a particular module or device may be performed by a different module or device without departing from the scope of the claims.

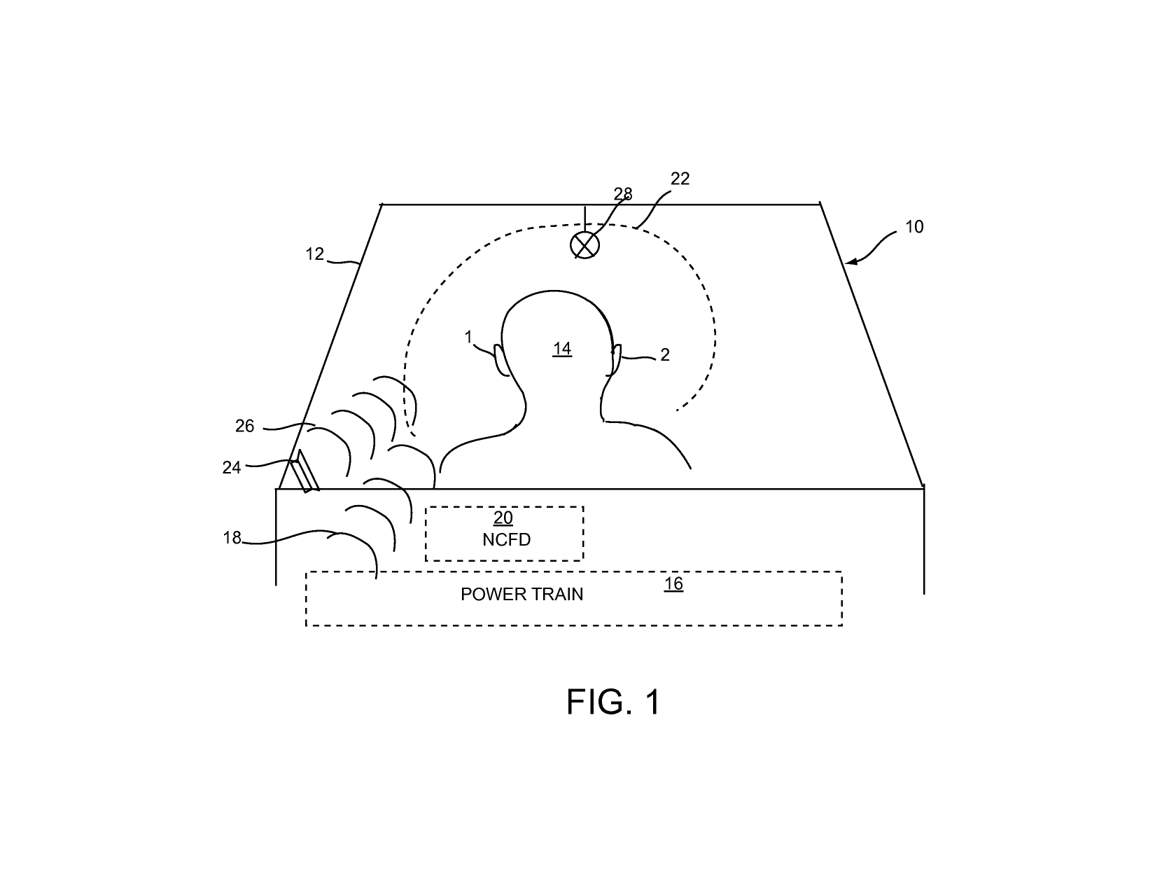

FIG. 1 shows a machine 10 having a cabin 12 occupied by an operator 14 having ears 1 and 2. In an example embodiment, the machine 10 is an agricultural machine such as, but not limited to a combine harvester, that is equipped with a powertrain 16 that generates acoustic noise 18 that can penetrate the cabin 12. In an example embodiment, the powertrain 16 can include an engine, a transmission, drive shafts, differentials, and a final drive. A noise cancellation fault detector (NCFD) 20 can be configured for canceling or suppressing noise associated with normal machine operation, such as normal powertrain 16 operation, to provide a quiet zone 22 around the operator 14. The NCFD 20 can cooperate with a speaker 24 to generate an acoustic cancellation signal 26 having waveform characteristics that configure it to destructively interfere with the noise 18 within the quiet zone 22.

The NCFD 20 can be configured to provide an audio cancellation signal that when transduced by the speaker 24 results in the acoustic cancellation signal 26 that can interfere with and suppress normal machine noise to provide a quieter environment for the operator 14. Because only normal machine noises are targeted for cancellation, noises associated with abnormal operation can remain present within the quiet zone 22, permitting the operator 14 to hear sounds typically associated with a failing machine 10 component, such as a failing part of the powertrain 16. The NCFD 20 can be electrically coupled to an existing audio system at the machine 10, so that the speaker 24 can be used to emit both a cancellation signal production and entertainment audio signals, such as those associated with playing a CD, mp3 file, or the like. While FIG. 1 depicts a single speaker 24, it is contemplated that a machine cabin can be equipped with two or more speakers, in which case the NCFD 20 can be coupled to more than one speaker and can be configured to provide more than one drive signal to cancel noise within the quiet zone 22.

In an example embodiment, a microphone 28 can be arranged in the cabin 12 so that it can detect “cleaned sound”, i.e. the resultant sound after the cancellation effects of the cancellation signal 26, within the quiet zone 22. The NCFD 20 can be configured to receive the cleaned sound audio signal produced by the microphone 28 and compare its waveform characteristics to those of waveforms associated with failing machine to detect a machine fault. A fault detection feature of the invention can provide a back-up system for operator fault detection that can be particularly useful when a machine is operated by an unskilled operator who lacks familiarity with the machine and its operating modes, and is thus unable to recognize audible fault indicators.

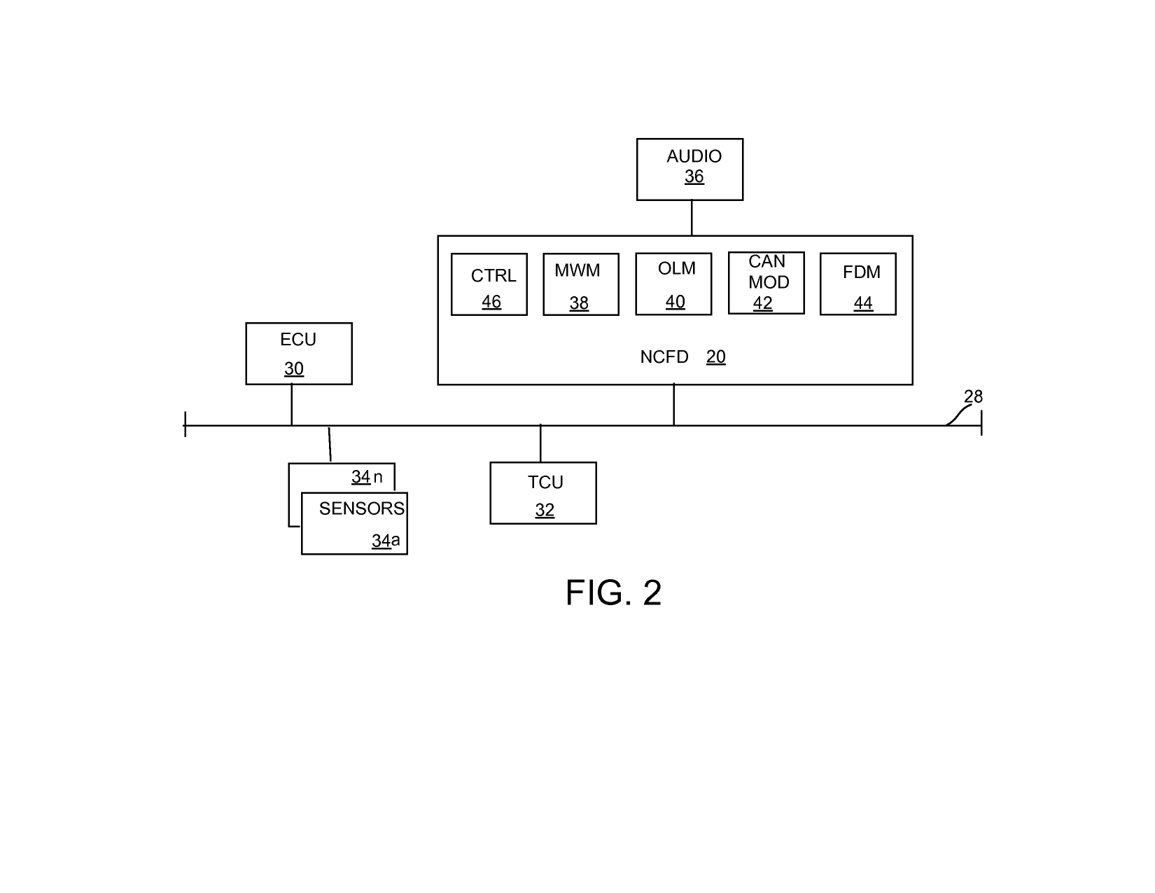

FIG. 2 shows a machine environment in which an NCFD can operate. A controller area network (CAN) bus 28 can communicatively couple the NCFD 20 to one or more electronic control units associated with various components of the machine 10. For example, an engine control unit (ECU) 30, a transmission control unit (TCU) 32, and sensors 34a to 34n can be coupled to the CAN bus 28. In an example embodiment, the sensors 34a . . . 34n can include an accelerometer, a camera, a microphone, a proximity sensor, and/or other sensor that can be used to detect sound and operator location within the cabin 12. The NCFD 20 can be directly coupled to an audio system 36 as shown in FIG. 1, or be coupled to a controller for the audio system 36 via the CAN bus 28. It is understood that other controller nodes a not shown here can be coupled to the CAN bus 28, and further understood that in some machine applications a CAN system can include more than one bus, for example a tractor bus and an interconnected implement bus.

In an example embodiment, the NCFD 20 can comprise a model waveform module (MWM) 38, an operator location module (OLM) 40, a cancellation module 42, a fault detection module (FDM) 44, and a controller module 46. Each of the modules 38-46 can comprise hardware, software, firmware or some combination thereof. The MWM 38 can be configured to provide a model waveform that represents “ideal” machine noise, i.e. noise generated by a machine that is operating normally. The MWM 38 can be configured to provide a model waveform based on machine type and machine input parameters, such as speed, rpm, load, and the like. A scalable model waveform can be provided by various methods. By way of example, actual machine acoustic signals can be used to provide a master or actual waveform. For instance, a microphone positioned in the machine cabin 12 can detect and transduce sound in the cabin 12 when the machine 10 is operating normally under a predetermined operating parameter, such as rpm, and the parameter can be changed to acquire various acoustic signals. A Fourier analysis can be performed on the acoustic signals to provide a frequency spectrum associated with the detected acoustic signals. Having acquired various actual waveforms, a process of constructing waveforms that “match” the actual ones can be performed. For example, one or more frequencies can be selected to provide a trial waveform, and the trial waveform can be compared to the actual waveform. An advantage of using a master waveform based on noise detection within a cabin is that the master waveform already reflects the effects of propagation from noise source to a cabin. Methods that detect noise at the source must adjust the detected signals for propagation effects to provide a master waveform expected in a cabin.

One method of producing a model waveform can include beginning with a selected frequency and incrementally adding additional frequencies, with each addition comparing the resultant waveform to an actual (master) waveform to determine whether to add or subtract additional frequencies until an acceptable waveform is produced for a given machine parameter or set of parameters. This method can produce a library of waveforms that can be selected by machine parameters.

However, because an actual noise (master) waveform can comprise thousands of frequencies, an attempt to construct a model waveform by adding individual frequencies one at a time and testing the combination, can prove time-consuming, especially if performed for various combinations of parameters. As an alternative, a non-deterministic system approach can be employed in which the MWM 38 can be configured to build a profile of machine noise based on a speed/load dynamic. For example, the MWM 38 can comprise a genetic algorithm configured to select a set of frequencies, combine them, and compare them to an actual or master waveform. Through evolution through a multitude of frequencies, similarities and deviations between selected frequencies and sets of frequencies can be observed and modeled in an algorithm to generate a model waveform in a process that can be similar to that employed in a neural network. Instead of having to model each parameter, frequency relationships can be used in an algorithm that, based on machine input parameters, converges toward a solution for all parameters. In an example embodiment, the engine controller 30 and/or the transmission controller 32 can be configured to provide machine operating parameters such as speed, rpm and load to the NCFD 20 via the CAN bus 28.

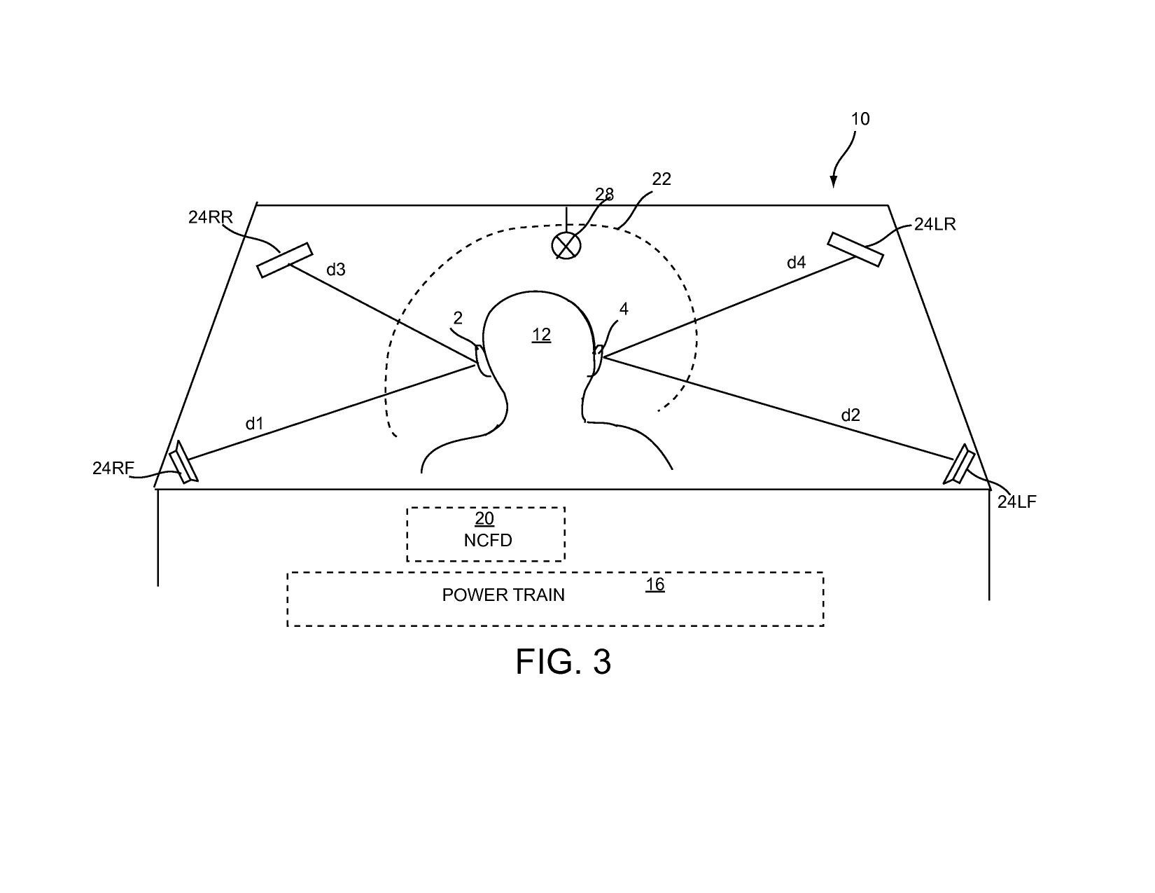

The OLM 40 can be configured to determine the location of the operator 14 within the cab 14, for example a user's location with respect to a speaker 24, and more particularly determine the location of the operator ears 1 and 2. In an example embodiment, a camera and/or one or more proximity sensors can be used to determine operator ear location. In an example method, position detection methods such as those described in “Image-Based Passenger Detection and Localization inside Vehicle” authored by Petko Faber and published in the International Archives of Photogrammetry and Remote Sensing, Vol. XXXIII, p. 230-237, Part B5, Amsterdam 2000, or those disclosed in U.S. Pat. No. 7,983,817, entitled “Method and Arrangement for Obtaining Information about Vehicle Occupants” issued to Breed on Jul. 19, 2011, or disclosed in U.S. Pat. No. 6,466,849 entitled “Occupant Position Detection System” issued to Kamiji et al. on Oct. 15, 2002, all of which are incorporated herein by reference, can be practiced to locate a user's ears. In an exemplary embodiment, the OLM 40 can be configured to determine the location of the ears 1 and 2 of the operator 14 with respect to one or more speakers 24 located within the cabin 12. For example, referring to FIG. 3, the OLM 40 can be configured to determine the distance dl of the operator ear 1 with respect to a front left speaker 24FL and d3 between operator ear 1 and a rear left speaker 24RL. Similarly, the OLM 40 can be configured to determine the distance d2 between the operator ear 2 and the front right speaker 24RL and the distance d4 between the operator ear 2 and the rear right speaker 24RR. It is contemplated that the orientation of the speaker with respect to a user's ear can also be considered. In an example embodiment, speakers are arranged so that a cancellation signal can be emitted from the same direction as normal machine sounds. In an example embodiment, the OLM 40 can determine the distance from a user's ear to one or more sensors use those distances to determine the distance between a speaker and a user ear. When developing a method to determine user location, a determination can be made as to whether movement along a vertical axis or horizontal axis has a greater influence on the noise cancellation effects, and this determination can be considered in both the operator location process and the configuration of a cancellation signal to provide a quiet zone around an operator.

The cancellation module 42 can be configured to provide a cancellation waveform based on the model waveform provided by the MWM 38. In an example embodiment, the model waveform can be inverted to provide a cancellation waveform 180° out of phase with the model waveform. The cancellation module 42 can further be configured to adjust the gain of an audio signal comprising the inverter waveform. For example, an audio cancellation signal for a rear speaker may have a different gain than an audio cancellation signal configured for a front speaker, a drive signal for a front speaker may have a different gain from a right side speaker, etc. The gain of a cancellation signal provided to a speaker can be adjusted to adequately cancel or suppress normal machine noise in the quiet zone 22 around an operator.

The cancellation module 42 can further be configured to determine and align the phases of the cancellation signals provided to one or more speakers so that the cancellation signals cancel rather than reinforce noise in the quiet zone 22. Operator ear location can be used to determine the phase of a cancellation signal. To facilitate the phase alignment process, one or more microphones can be positioned to provide audio signals of the machine noise in the cabin 12. Detection of cabin noise characteristics, determination of operator location, and knowledge of signal frequencies can allow the phases of the various cancellation signals to be determined by the propagation delays from a speaker to the quiet zone 22, and allow alignment to be performed so that the cancellation signals destructively interfere with the cabin noise within the quiet zone 22. The properly adjusted and aligned inverted waveform provides an audio cancellation signal that can be provided to a speaker 24 of a machine audio system. In an example embodiment, the cancellation module 42 can comprise a digital signal processor configured to calculate the gains and phases and generate the audio cancellation signal based on the adjusted inverted waveform. The speaker 24 can be configured to produce an acoustic cancellation signal based on the audio cancellation signal provided by the cancellation module 42.

The NCFD 20 can further include the FDM 44 which can be configured to compare an audio signal representing the “cleaned sound” within the quiet zone to fault waveforms associated with various machine failure modes. In an example embodiment, the FDM 44 can comprise a library of waveforms associated with various components that have failed or are beginning to fail. To compile the fault waveform library, one or more microphones can be positioned in a cabin of a machine to detect the sounds heard when a machine component is in a failure mode. Sounds like whining or pinging, or noises associated with a turbocharger, a piston, a bearing, etc. can be used to develop a fault waveform library. As an alternative, an accelerometer or microphone can be positioned at a component that is not operating properly, rather than in a cabin, to provide an audio signal of the sound produced. In an example embodiment, test equipment configured to produce machine failures can be used to generate acoustic signals or vibration patterns that can be detected by a microphone or accelerometer. The waveform characteristics of the audio signal can be stored in a memory at the FDM 44. The FDM 44 can be configured to compare an incoming cleaned sound audio signal with the various stored waveforms to detect a match, in a process similar to voice recognition technologies as known in the art. In a further embodiment, a microphone or accelerometer at a failing component, rather than within the quiet zone 22 can be used to provide an audio signal that can be compared with the fault waveforms stored at the FDM 44.

The example NCFD 20 can also include a controller 46 that can be configured to coordinate operation of the various modules. In an example embodiment, the controller 46 can include a digital signal processor and/or a microcontroller that can be configured to perform some or all the operations associated with the modules 38-44 as well as interface with the CAN bus 28.

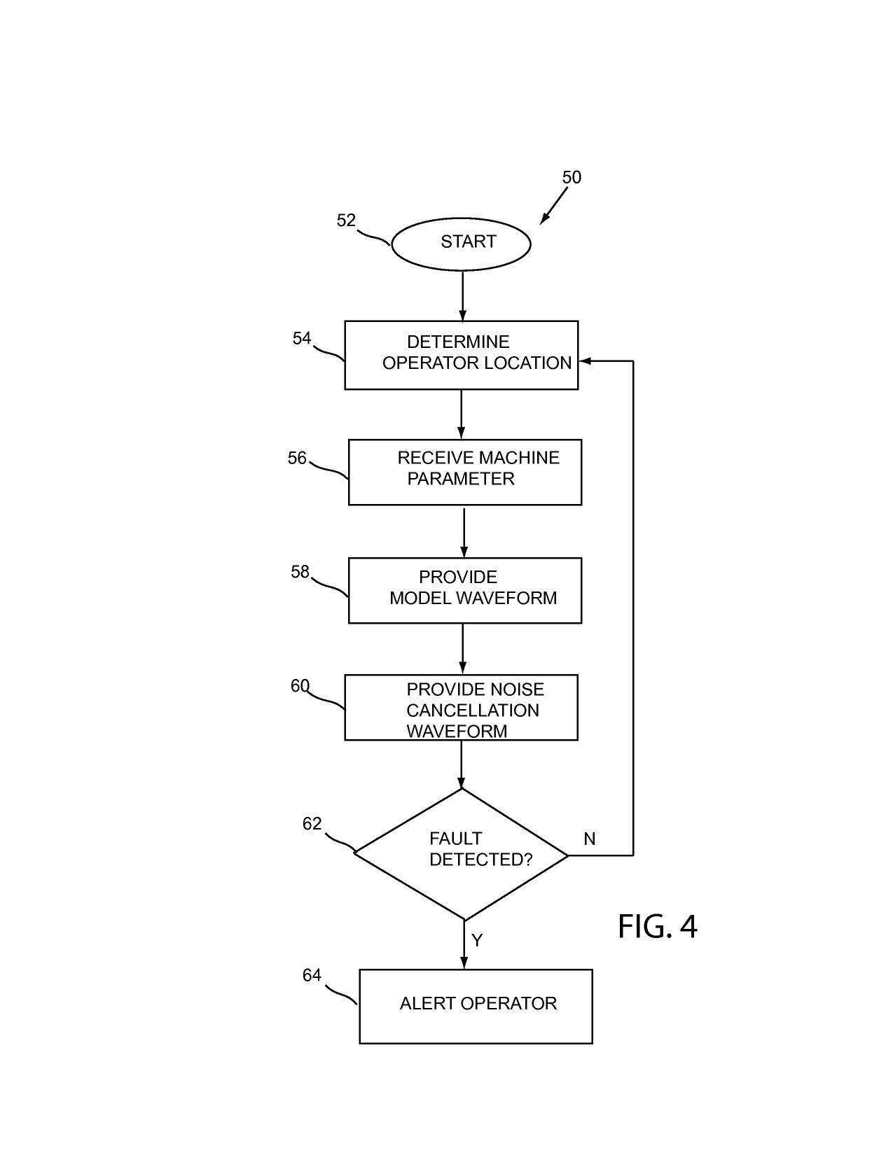

FIG. 4 shows an example method 50 of the invention. At block 52 the method can begin. At block 54, operator location can be determined. For example, the OLM 40 can detect the location of the operator ears 1 and 2. In an example embodiment, the location does not have to be extremely precise, rather ear location can be determined within a predetermined margin of error. At block 56 machine parameters such as speed, rpm and/or load can be received at an NCFD. For example, the controller 46 can receive machine parameters from the engine control unit 30 via the CAN bus 28. At block 58 a model waveform can be provided. For example, the MWM 38 can provide a model waveform based on the parameters received at the controller 46, using a genetic algorithm discussed previously herein. At block 60 a cancellation signal can be provided. For example, the cancellation module 42 can invert the model waveform provided by the MWM 38, adjust the gain, and align the phases based on the operator location determined at the OLM 40. An audio signal from the cabin 12 can also be used in the phase alignment process. The aligned and adjusted inverted waveform (audio cancellation signal) can be provided to a speaker at the cabin 12 which can be configured to use the audio cancellation signal to provide an acoustic cancellation signal to the cabin 12. In an example embodiment, a plurality of speakers are deployed in the cabin 12, each receiving a cancellation signal having a phase that depends on the operator location with respect to the speaker so that the acoustic signals emitted by the speakers destructively interfere with normal machine sounds within the quiet zone 22.

At decision block 62, a determination can be made as to whether a fault is present at a machine. For example the microphone 28 can provide an audio signal representing cleaned sound within the quiet zone 22. The cleaned sound signal can be compared to various fault waveforms stored at the FD 44 to detect the presence of a failure mode at the machine. If a fault is detected, an alert, such as an audible alarm, can be provided at block 64.

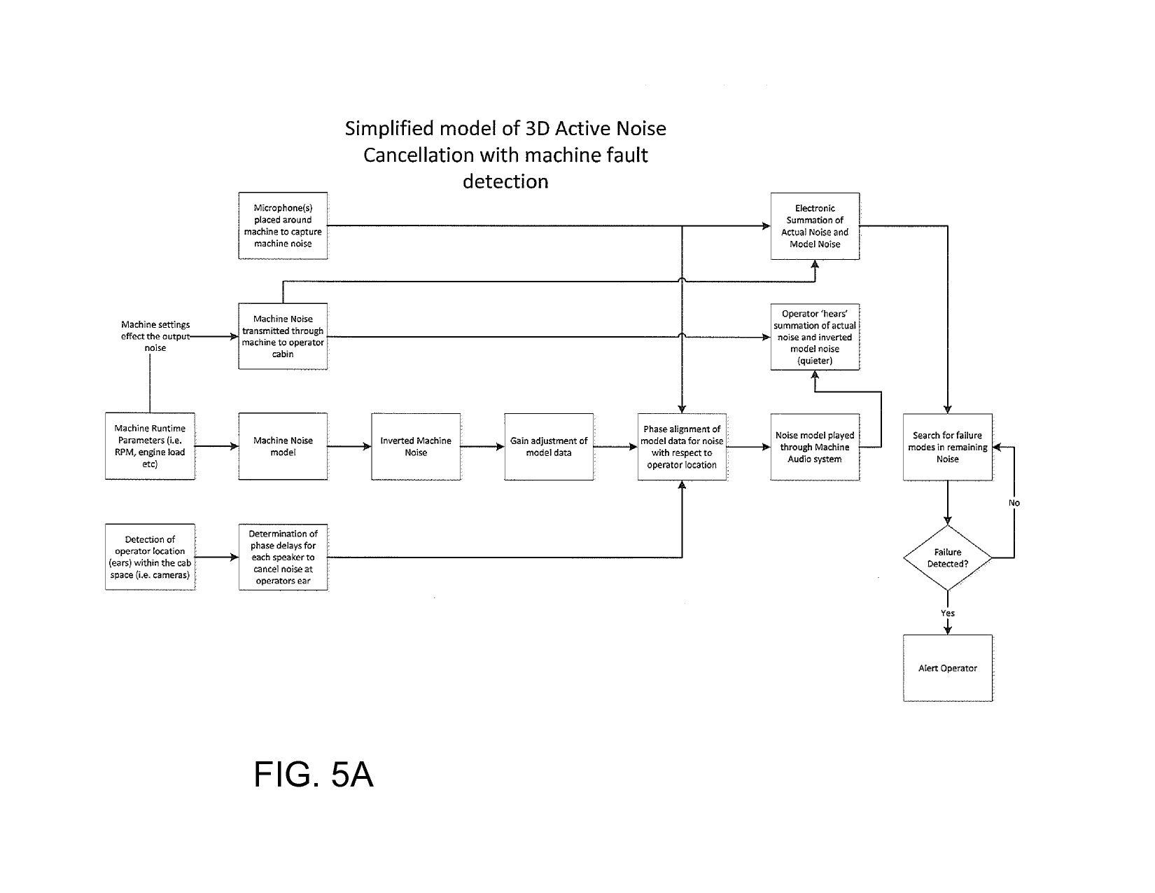

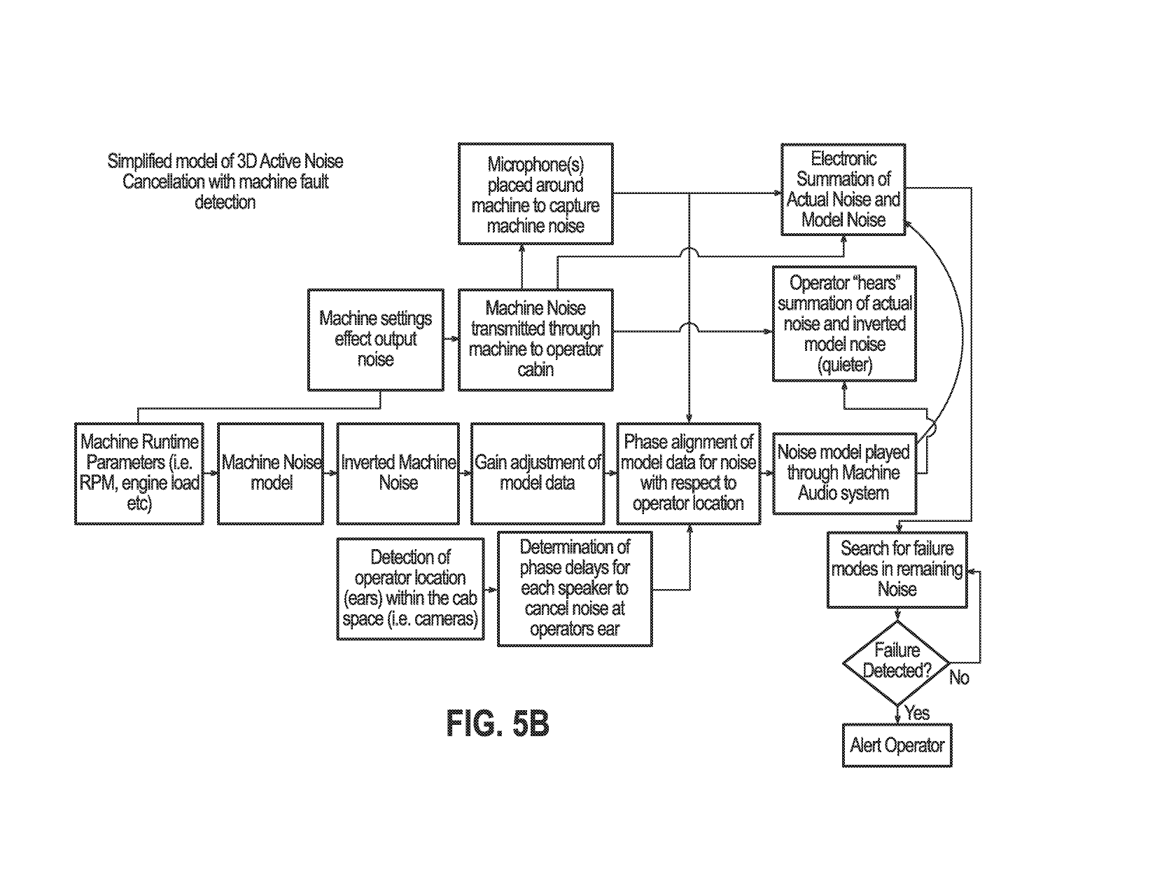

FIGS. 5A and 5B show example invention embodiments, showing the processes that can be performed in practicing the invention.

The present invention provides systems, apparatus and methods for active noise cancellation that selectively targets normal operational noise, as opposed to targeting all cabin noise. The invention can provide a quiet zone around an operator that allows him to hear sounds associated with failure modes while normal operational sounds are suppressed. Because an operator can still hear noises that indicate a component is failing or beginning to fail, he can promptly attend to the problem and avoid the more costly repairs that could result if the problem is allowed to worsen. As a backup to operator detection of failure modes, the invention can include a fault detection aspect in which the cleaned sound of the quiet zone is compared to fault waveforms so that an operator who fails to recognize a failing component can be alerted. Implementation of active noise cancellation techniques reduces the need for expensive passive measures, thus lowering manufacturing costs. Rather than providing a quiet cabin, the invention can provide a quiet zone that can move with an operator.

In consumer electronics, for instance Bose headphones, microphones pick up signals live, a processor inverts them with a short delay, and feeds the inverted signal which cancels the real signal to reduce noise. In agricultural machines a user wants to hear sounds that indicate that something is amiss, but doesn't necessarily want to hear loud normal engine sounds. The problem posed is how to keep the noise that is desired while getting rid of other undesired noise. Desired noise includes changes in engine noise that indicate a problem.

One can model noise using speed, rpms, and engine load, and build a profile of engine noise on a speed/load dynamic. If you invert that perfect engine noise you are left with deviations from the normal engine noise or hum. You can produce an environment that is relatively quiet, in which volume is decreased, noise is not totally eliminated as you are left with deviations indicating that something is wrong.

If speakers are on your ears, like the Bose headphones, it doesn't matter where you are, they follow you around. But in a machine cab, with speakers located a fixed distance away from you, as an operator moves around a cab, he will move through different troughs and amplitudes. He can move out of a quiet zone so to speak if he moves far enough, because instead of hearing quiet, he is hearing double the noise. So what has to be done is, depending on where the person is, you can direct the noise to be in an envelope, e.g. a quiet envelope, around a person. You don't need the cab to be quiet, you need an area around an operator's ears to be quiet. Essentially, you can adjust speaker output in accordance with where an operator's ears are. The technology of locating an operator's ear(s) can be done.

You can use a digital signal processor to do the math that is involved, once you have located the ears, the distance between the ears and the speaker, the time of propagation for sound wave to make sure that it arrives at the same time with the same phase as the noise that is coming in. A lot of machines have built-in speakers already, so you model the location of the person's head relative to the speaker location and do some modeling for variation of where they are, for example variation in height, and in left/right direction. Essentially you can encourage them to be within an envelope anyway, because that is where it is quiet. You can start changing signal. It ends up being complicated math, but a processor will do it for you so it essentially zeroes out within an envelope around your head. So two primary things are being done: modellling engine noise and making it so you only hear noise that you want to hear, and changing it as a function of a person's position in a cab.

Looking at flow chart, at bottom left there is the detection of an operator location: where he is, where he is facing. It doesn't have to be accurate. Its easy to work out where he is, you can have a sensor above his head, camera/film, where he is relative to his surroundings. Proximity sensors can be used. Modelling can be used to incorporate factors such as cab structure and operator height. Depending on the cab structure, a particular axis may affect sound the most, it may be that vertical variations have little effect and most variation is from right and left. If you change height, the distance between both speakers is the same or small, but if you go left/right, that is when you have to change left side relative to right side. Modelling can be used to see how big that envelope is. If you have inches within envelope, then small movements while sitting in the machine won't affect it much.

The reason speakers are built into cab is that operators like to listen to music. We can play sound back through the speakers, so if an operator is listening to music, you are taking away from that noise, but maybe you find better position for speakers in cab fortuitous for this design, allowing them to listen to stereo. If it turns out that with current speaker location the operator is limited in movement, but with new speaker location, say 2 left and right, and 2 front and back, may mean more design work in cab, but still get same function, but better for noise cancellation, is worth consideration.

So go from determining operator location to determining things like phase delays to speaker, so work out distances. Depending on frequency of sound, work out propagation times/delays. Peaks and troughs have to hit opposite engine sound. If you are looking at me straight on, (you are engine), I am sitting in cab noise incident this way. Ideally you would like speakers emitting sound from same direction as noise is coming from, otherwise a bit more complicated for compensation. Then essentially that is coming in to addition. If you look at box above “Machine Run time Parameters” (rpm, engine load) ambient engine noise. Theory “all sound made of multiple waveforms, you get enough of those and you hear speech, music, things like that. So essentially, going the other way, you can decompose using Fourier analysis, can decompose back to frequency spectrum. So what you essentially are trying to do, is take a number of acoustic readings of engines at different rpms, what you want to do first of all, when engine is stationary, unloaded engine, then change variables, vary the rpm, hear different noises as engine changes revs, and then do frequency analysis to model where peaks are, then start with blank slate. You can start playing back number of waveforms that represent the big peaks. You can also do it a bit differently, instead of adding peaks in one by one, since we are talking about multiple frequencies, thousands of frequencies. If you just pick a peak here, then something else gets added and it can become a negative, and it gets complicated. So can write genetic algorithm that selected frequencies, then added them, then compared them to pattern they are checked against, then it evolved to the best combination of frequencies that met the model noise. Then, if do an evolution for a multitude of these frequencies, then look for evolved sets of frequencies, similarities between/among them, deviations between them, that can be modeled. Can come up with multiple waveforms, not just repetitions, things vary: rpm, load. Would like to use genetic algorithm based on evolutions, rather than a deterministic function, use non-deterministic. If you had small variation and look at differences, you can create a population. So if have population of frequencies, this is one wave oat 5 Hz, this one at 10 Hz, 100 Hz, etc. then I compare them to master signal and see which one is best and throw away the rest. Then can make mutation, say add a bit of noise, add a bit to the frequency, maybe add another frequency wave. You can essentially propagate success. After you do this enough times, it tends toward a solution(s) that are very likely. Can build wound waves from single frequencies that have evolved/modeled that sound like tractors. Once you can determine relationships between them, put in neural network, that is good way of looking at disparate variables. You don't have to have a model at this tractor at this rpm, you can fill in gaps, don't have to model every parameter on everything at the same time if I can describe the relationships in one way, it can try to work it out and find solution that works for all. Can give it direction and constraint and algorithm can find solution. For example, can give it certain variables like load, rpm, etc.

There is a lot of noise in cab and you want to bring noise level down, you may not model it perfectly, it may not be silent like Bose speakers. There is a lot of chaotic random noise, but can get it down to lower magnitude. So basically, based on variables, you generate number of frequency waveforms, e.g. waveform at 100 Hz at angle X, at phase offset Y, there are a number of variables associated with each wave. For example, may consider optimum number of waves is 10 waves, then for any parameters loaded in, it will generate these waves, or at least these frequencies, which will be put into digital signal processor, then they will be generated out of speaker system. Sensors for variables (rpm, engine load, speed) are often already available on machines, and variables may be available from engine control unit. We could add more. So invention can use modeling for an effect that is not complete noise suppression. (In some industrial applications fan noise through duct is modeled and used to reduce noise.) Maybe engine noise isn't the only thing to consider, maybe people value engine noise too much, may want to model other periodic noises to take noise away from the sounds that you want to consider.

Then we invert the model and do adjustments to the model data. Gain can be considered volume. When sound comes in to cabin from engine, it can be in form of single sine wave. For example, can model at 100 Hz, invert it, and then match the amplitude (gain) and have to get phase as well, so that the peak and trough cancel each other out. As you get higher in rpms, the inherent noise envelope gets bigger as well. The model is a skeleton, has to be tweaked as it goes out.

As for model, could go back to mechanical system and try to isolate all components of system and build it up from scratch. But could take systems approach and assume you have whole vehicle, then measure the noise and try to get rid of that noise. A more pure way of modeling can be done that begins with engine on stand, remove gearbox noise, then exhaust noise, then model engine or model transmission, model exhaust, do those things separately, then have some sort of filtering as it comes through the cab. Systems approach starts with microphones where operator is going to be because that is where the “ears” are going to end up, so it doesn't matter what it sounds like 10 feet to left of cab, because you are trying to suppress noise where the operator is going to be. So you can model it this way. You could do both, just part of modeling process. You could put microphone in cab, record sound where operator is.

In middle of the included flow diagram is where phase alignment is done. Then we go back through the audio system, and you get summation above that, which is what the operator actually hears. Essentially, there are two things going through that box: the model that is going into that from the bottom, and from the left, the machine noise transmitted through the cab. The idea is that we do all preprocessing at the beginning: modeling of engine, do all the work, determining the optimum number of waves. The more waves you have, the more CPU needed and used, want to find happy medium between number of waves and sound reduction. For example, had 60% reduction with 10 waves, and needed 100 waves to get to 59% reduction, then payoff not worth extra work.

Going down right side, there is fault identification. You know how mechanic listens to automobile and can tell from sound what is wrong? How do you teach computer what they know? There are certain noises that mean different things. What you can do, instead of causing those failures in a lab and recording them and characterizing them, computers can pick these noises up at volumes a lot lower than human sensitivity, they can start characterizing like “starting to sound like getting knocking”. Acoustic fault detection: by eliminating some of the noise we are better able to detect that there is sound that can be used for diagnostics. The model just has the “rrrr” of normal engine, once you get rid of that, you can hear pings, knocks, etc., that can indicate turbocharger, piston or bearing problem. You can start characterizing a number of these, you can do some collections, or if you've got machines that cause certain engines to fail in certain ways, then model that data, record the sound that comes back from that, and try to start characterizing. You can build up a database, so could give prognostic warnings to operator: “something here appears abnormal, get it checked, it could be . . . .” You could have sensors where operator is, or sensors at engine, etc.

Current speaker location depends on the cab. You can have microphone suspended by string where operator will be, or have 2 microphones pointing away from each other, omni microphone, etc. You can have some sort of sound alignment to perform phase alignment. Model is right, it's just moving around in space, so it needs to be lined up. So you can have at least 1 microphone in cab to line them up. You could also have additional microphones in cab, or accelerometer at engine to pick up vibrations which cause sound. The invention can use a lot of stuff already currently available at machine: speed, engine load, rpm inputs, speakers. May not have the microphones and/or things to do the gain/phase alignments, although do have some things on machines that have accelerometers. Can use a digital signal processor, perhaps use an existing processor embedded in a machine ECU. Machine inputs rpm, load, speed, can be transmitted on CAN bus. The inputs can be fed to model, which, based on the inputs, will provide an output, which can be an envelope having a set of frequencies, a size and shape. A different model can be provided for different machines. Then, you can adjust phase and gain of the model output. Microphone input can be used for alignment. You can consider propagation of sound, computing delays, etc. If you know the time it takes for sound to propagate and long it will take the CPU to perform calculations, you can do the alignments. For example, if you have a microphone or accelerometer located in engine bay, you can perhaps find correlation between an acceleration and a peak of the sound. Then you can combine it with the sound of the speakers.

Skilled service techs who know machinery can be pretty astute at detecting problems by listening to machine sounds, and they won't let a machine operate for a prolonged period when something doesn't sound right. But if you have unskilled labor at the helm, since advanced technology allows more unskilled labor, they may not detect it. The prognostics aspect of the invention could tell them whether something is seriously wrong, or whether there is no need to worry, and by doing so you increase confidence of the owner that valuable equipment will not be destroyed by unskilled labor.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A system comprising:
a noise suppression fault detector (NSFD) configured to provide a model waveform based on one or more machine parameters, and provide an audio cancellation signal based on said model waveform, said audio cancellation signal having a phase dependent on a user location; and
a speaker configured to receive said audio cancellation signal and provide an acoustic cancellation signal.

2. The system of claim 1, further comprising a second speaker configured to provide a second acoustic cancellation signal, said second cancellation signal phase dependent on said user location.

3. The system of claim 1, wherein said system is configured to provide a quiet zone around said user in which said cancellation signal destructively interferes with normal machine noise.

4. The system of claim 3, further comprising at least one microphone positioned within said quiet zone and configured to detect sound therein.

5. The system of claim 4, configured to use said detected sound to detect a machine fault.

6. The system of claim 1, further comprising at least one microphone positioned in said user environment and configured to provide an audio signal used to align the phase of said audio cancellation signal.

7. A noise suppression fault detector (NSFD), comprising:
a model waveform module configured to provide a model waveform based on at least one machine parameter;
an operator location module configured to determine location of an operator;
a cancellation module configured to provide a cancellation signal based on said model waveform and said user location; and
a fault detection module configured to compare an audio signal to a fault waveform.

8. The NSFD of claim 7, wherein said model waveform is scalable with respect to said machine parameter.

9. The NSFD of claim 7, wherein said cancellation signal is configured to destructively interfere with machine-generated noise within a quiet zone around said user.

10. The NSFD of claim 7, wherein operator location comprises an operator ear location relative to a speaker, and said cancellation signal has a phase dependent on said operator ear location.

11. The NSFD of claim 7, wherein said cancellation module comprises a digital signal processor configured to invert said model noise waveform to provide an inverted model waveform and align phase of said inverted model waveform based on said user location to provide said cancellation signal.

12. The NSFD of claim 12, wherein said cancellation module is configured to adjust gain of said inverted model waveform to provide said cancellation signal.

13. A method, comprising:
determining operator location;
receiving at least one machine parameter;
providing a model waveform configured to represent normal machine operation noise within said machine cabin based on said machine parameter; and
providing a noise cancellation waveform to a speaker at said cabin.

14. The method of claim 13, wherein said providing said cancellation waveform comprises inverting said model waveform to provide an inverted model waveform.

15. The method of claim 13, wherein said providing said cancellation waveform comprises adjusting at least one parameter of said inverted model waveform based on said operator location.

16. The method of claim 15, wherein said adjusting at least one parameter of said inverted model waveform comprises adjusting the phase.

17. The method of claim 13, further comprising providing a second cancellation waveform to a second speaker at said operator cabin.

18. The method of claim 13, further comprising detecting sound within said quiet zone.

19. The method of claim 18, further comprising using said detected sound to detect a machine fault.

20. The method of claim 19, wherein said using said detected sound to detect a machine fault comprises comparing said detected sound to a fault profile.
